(19) United States
(12) Patent Application Publication
(10) Pub. No.: US 2020/0213997 A1
(43) Pub. Date: Jul. 2, 2020

(54) RESOURCE CONFIGURATION METHOD, BASE STATION, TERMINAL, AND COMPUTER READABLE STORAGE MEDIUM

(71) Applicant: VIVO MOBILE COMMUNICATION CO., LTD., Chang'an Dongguan (CN)

(72) Inventors: Zhi LU, Chang'an Dongguan (CN); Xiaodong SHEN, Chang'an Dongguan (CN); Na LI, Chang'an Dongguan (CN)

(73) Assignee: VIVO MOBILE COMMUNICATION CO., LTD., Chang'an Dongguan (CN)

(21) Appl. No.: 16/622,522

(22) PCT Filed: Jun. 12, 2018
(86) PCT No.: PCT/CN18/90793

§ 371 Date: Dec. 13, 2019

(30) Foreign Application Priority Data
Jun. 14, 2017 (CN) 201710454486.X

(51) Int. Cl. H04W 72/04; H04L 1/18

(52) U.S. Cl. CPC H04W 72/0413; H04L 1/1861; H04W 72/042

(57) ABSTRACT

The present disclosure provides a resource configuration method, a base station, a terminal and a computer readable storage medium. The resource configuration method includes: transmitting configuration information of a physical uplink control channel (PUCCH) resource to a terminal. The configuration information includes at least one of a time interval from downlink data to feeding back PUCCH resource, waveform information employed for transmitting the PUCCH resource, acknowledgement/non-acknowledgement resource indication information, format information employed for feeding back the PUCCH resource, and frequency hopping identification information of the PUCCH resource.

### CROSS-REFERENCE TO RELATED APPLICATION

This application is the U.S. national phase of PCT Application PCT/CN2018/090793 filed on Jun. 12, 2018, which claims the priority of the Chinese patent application No. 201710454486.X filed on Jun. 14, 2017, which is incorporated herein by reference in its entirety.

### TECHNICAL FIELD

The present disclosure relates to the field of communication technologies, and in particular to a resource configuration method, a base station, a terminal and a computer readable storage medium.

### BACKGROUND

Generally, the Physical Uplink Control Channel (PUCCH) resource of downlink traffic in LTE is implicitly determined by a minimum Control Channel Element (CCE) of Physical downlink Control Channel (PDCCH). The timing of the PUCCH (also referred to as timing sequence) is determined according to a fixed timing relationship. For New Radio (NR), there are different lengths of PUCCH formats due to the introduction of different numerologies. Different slot structures makes it difficult to determine the timing relationship of PUCCH.

Compared with the existing mobile communication systems, the future 5G mobile communication systems need to adapt to more diverse scenarios and business needs. The main scenarios of 5G include enhanced mobile broadband (eMBB), Ultra-Reliable Low Latency Communications (URLLC), and massive machine-type communications (mMTC), which require high reliability, low latency, large bandwidth and wide coverage. For services in some scenarios, higher bandwidth transmission is required to provide higher transmission rates. However, the existing PUCCH configuration mode in LTE cannot guarantee the reliability of 5G communication.

### SUMMARY

An embodiment of the present disclosure provides a resource configuration method, including:

transmitting configuration information of a physical uplink control channel (PUCCH) resource to a terminal;

wherein the configuration information includes at least one of a time interval from downlink data to feeding back PUCCH resource, waveform information employed for transmitting the PUCCH resource, acknowledgement/non-acknowledgement resource indication information, format information employed for feeding back the PUCCH resource, and frequency hopping identification information of the PUCCH resource.

An embodiment of the present disclosure provides a resource configuration method, including:

acquiring configuration information of a physical uplink control channel (PUCCH) resource sent by a base station;

wherein the configuration information includes at least one of a time interval from downlink data to feeding back PUCCH resource, waveform information employed for transmitting the PUCCH resource, acknowledgement/non-acknowledgement resource indication information, format information employed for feeding back the PUCCH resource, and frequency hopping identification information of the PUCCH resource.

An embodiment of the present disclosure provides a base station, including:

a transmission module configured to transmit configuration information of a physical uplink control channel (PUCCH) resource to a terminal;

wherein the configuration information includes at least one of a time interval from downlink data to feeding back PUCCH resource, waveform information employed for transmitting the PUCCH resource, acknowledgement/non-acknowledgement resource indication information, format information employed for feeding back the PUCCH resource, and frequency hopping identification information of the PUCCH resource.

An embodiment of the present disclosure provides a base station, including: a memory, a processor, and a computer program stored on the memory and executable on the processor; wherein the computer program is executed by the processor to implement steps of the above resource configuration method.

An embodiment of the present disclosure provides a computer readable storage medium, including a computer program stored thereon; wherein the computer program is executed by a processor to implement steps of the above resource configuration method.

An embodiment of the present disclosure provides a terminal, including:

an acquiring module configured to acquire configuration information of a physical uplink control channel (PUCCH) resource sent by a base station;

wherein the configuration information includes at least one of a time interval from downlink data to feeding back PUCCH resource, waveform information employed for transmitting the PUCCH resource, acknowledgement/non-acknowledgement resource indication information, format information employed for feeding back the PUCCH resource, and frequency hopping identification information of the PUCCH resource.

An embodiment of the present disclosure provides a terminal, including: a memory, a processor, and a computer program stored on the memory and executable on the processor; wherein the computer program is executed by the processor to implement steps of the above resource configuration method.

An embodiment of the present disclosure provides a computer readable storage medium, including a computer program stored thereon; wherein the computer program is executed by a processor to implement steps of the above resource configuration method.

### BRIEF DESCRIPTION OF THE DRAWINGS

FIG. 1 is a first schematic flowchart of a resource configuration method according to an embodiment of the present disclosure;

FIG. 2 is a schematic diagram showing positional relationship of a time interval;

FIG. 3 is a schematic diagram showing a format division of a PUCCH;

FIG. 4 is a schematic diagram showing CP-OFDM frequency hopping of 1 symbol within one bandwidth part;

FIG. 5 is a schematic diagram showing frequency hopping of 2 symbols within one bandwidth part;

FIG. 6 is a schematic diagram showing frequency hopping of 2 symbols between bandwidth parts;

FIG. 7 is a schematic diagram showing frequency hopping of 7 symbols between bandwidth parts;

FIG. 8 is a second schematic flowchart of a resource configuration method according to an embodiment of the present disclosure;

FIG. 9 is a block diagram of a base station according to an embodiment of the present disclosure;

FIG. 10 is a block diagram showing structure of a base station according to an embodiment of the present disclosure;

FIG. 11 is a block diagram of a terminal according to an embodiment of the present disclosure; and

FIG. 12 is a block diagram showing structure of a terminal according to an embodiment of the present disclosure.

### DETAILED DESCRIPTION

In order to make the objects, the technical solutions and the advantages of the present disclosure more apparent, the present disclosure will be described in details hereinafter in conjunction with the drawings and embodiments.

In view of the problem that the PUCCH determination mode in the related art cannot guarantee the reliability of 5G communication, the present disclosure provides a resource configuration method, a base station, a terminal and a computer readable storage medium.

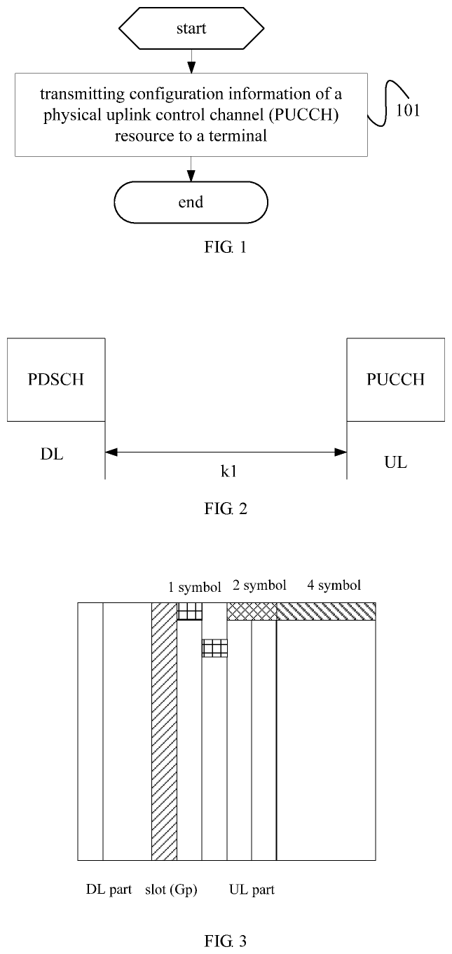

As shown in FIG. 1, one embodiment of the present disclosure provides a resource configuration method, which is applied to a base station, and includes:

Step 101: transmitting configuration information of a physical uplink control channel (PUCCH) resource to a terminal.

The configuration information includes at least one of a time interval from downlink data to feeding back PUCCH resource, waveform information employed for transmitting the PUCCH resource, acknowledgement/non-acknowledgement resource indication information, format information employed for feeding back the PUCCH resource, and frequency hopping identification information of the PUCCH resource.

It should be noted that, the base station usually transmits the configuration information to a terminal through downlink control information (DCI). When receiving by the terminal, the terminal first receives the DCI, and then extracts the configuration information of the PUCCH resource in the DCI.

Specifically, when the configuration information includes the time interval from the downlink data to feeding back PUCCH resource, the time interval is one of a plurality of preset time intervals. The plurality of preset time intervals are set at equal intervals or unequal intervals.

For example, as shown in FIG. 2, the time interval (k1) is a duration between after transmission of physical downlink shared channel (PDSCH) and before transmission of the PUCCH.

The time interval may be expressed by a specific time or by a quantity of slots. When setting the plurality of preset time intervals, the plurality of preset time intervals may be set at equal intervals, for example, (1, 2, 3, 4) slots. The plurality of preset time intervals may also be set at unequal intervals, for example, (1, 2, 3, 6) slots. Specifically, the preset time interval is configured by a high layer.

It should be noted that two types of waveforms may be employed for transmission of the uplink PUCCH. One is DFT-spread-orthogonal frequency division multiplexing (DFT-S-OFDM)-based waveform, and the other is cyclic prefix orthogonal frequency division multiplexing (CP-OFDM)-based waveform. Then, a 1-bit waveform indication can be introduced to indicate which waveform is employed by the PUCCH channel, and two states of the bit represent two waveforms, respectively.

Specifically, when the configuration information includes the acknowledgement/non-acknowledgement resource indication information, the acknowledgement/non-acknowledgement resource indication information includes: a resource set comprised of at least one resource; or, the acknowledgement/non-acknowledgement resource indication information includes: a resource and at least one offset.

For PUCCH channel, it is usually shared by multiple terminals. If each terminal is allocated with a fixed PUCCH resource, when the terminal has no service, the resource may be idle and this reduces resource utilization efficiency. When the acknowledgment/non-acknowledgement (ACK/NACK) resource indication information includes a resource set comprised of at least one resource, a resource available to the terminal for transmitting PUCCH is indicated by using the DCI to indicate one resource in the configured resource set. When the acknowledgment/non-acknowledgement resource indication information includes a resource and at least one offset, a specific resource available to the terminal can be obtained through calculation based on the resource and the offset.

Specifically, when the configuration information includes the format information employed for feeding back the PUCCH resource, if there are definite PUCCH formats and quantity in a slot, then the format information includes PUCCH identification information; if an uplink of a slot or an uplink slot includes dynamically variable PUCCH formats, then the format information includes a starting symbol position of the PUCCH and a length of the PUCCH.

The PUCCH format may be implemented in the following two ways:

1. If there are definite PUCCH formats and quantity in a slot, then, a sequence number carrying PUCCH format in the DCI can indicate which PUCCH the terminal can use. As shown in FIG. 3, in an uplink (UL) part of a slot, there are four PUCCHs including two 1-symbol PUCCHs, one 2-symbol PUCCH and one 4-symbol PUCCH. The DCI can indicate which PUCCH format to use with 2 bits.

2. If an uplink of a slot or an uplink slot includes dynamically variable PUCCH formats, then it is necessary to indicate format and location of which PUCCH the terminal specifically uses; a starting symbol of the PUCCH and a length of the PUCCH may be notified in the DCI.

It should be noted that the NR supports short PUCCH of 1 or 2 symbols, and the NR also supports long PUCCH of 4-14 symbols, thus multiple PUCCH formats can be defined and each PUCCH may correspond to a varied quantity of symbols or bearing capacity. For configuration of the PUCCH transmission format of smaller bits, if there are many configuration parameters, the signaling overhead is too large and the resource utilization efficiency is not high. Therefore, for the PUCCH transmission format of smaller bits, the PUCCH resource may be implicitly determined. At this point, a time domain position (i.e., a starting OFDM symbol and a length) of a PUCCH channel in one slot may be configured by the upper layer, and an available resource may be implicitly determined (according to CCE and other information) or may be configured to the terminal. If UCI information that the terminal needs to feed back is small (i.e., smaller than or equal to a preset value), a small-capacity PUCCH is used.

The PUCCH format indicated in the DCI may implicitly indicate uplink control information (UCI) sent by the terminal. For example, if the indicated PUCCH format has a capacity of 1-2 bits, then the terminal only transmits ACK/NACK information. If the indicated format is greater than or equal to a preset quantity of bits, ACK/NACK and Channel Quality Indicator (CQI) information are transmitted simultaneously.

Specifically, when the configuration information includes the frequency hopping identification information of the PUCCH resource, the frequency hopping identification information includes: frequency hopping indication information and/or a long-PUCCH resource frequency hopping division indication.

The frequency hopping indication information includes: an intra-bandwidth part (BP) frequency hopping indication or an inter-BP frequency hopping indication.

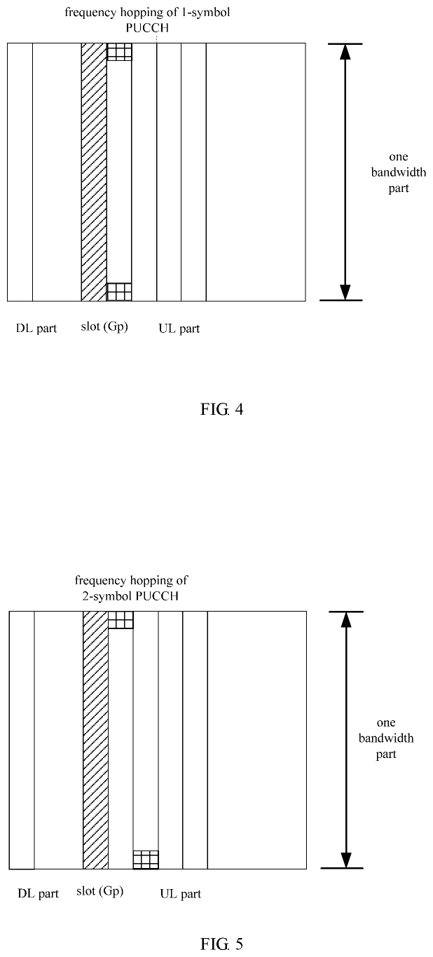

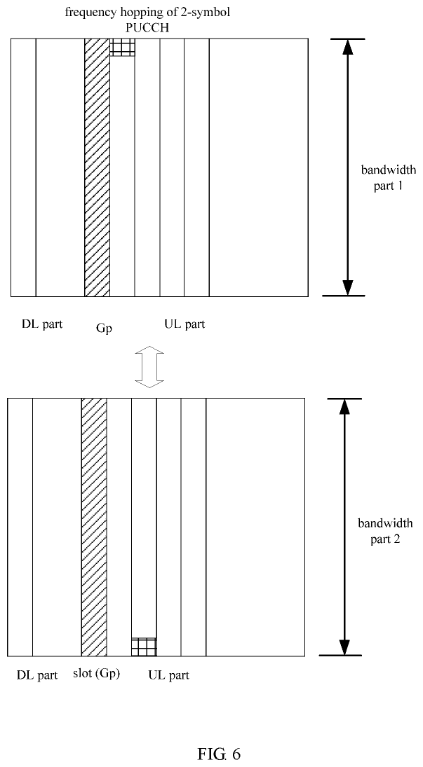

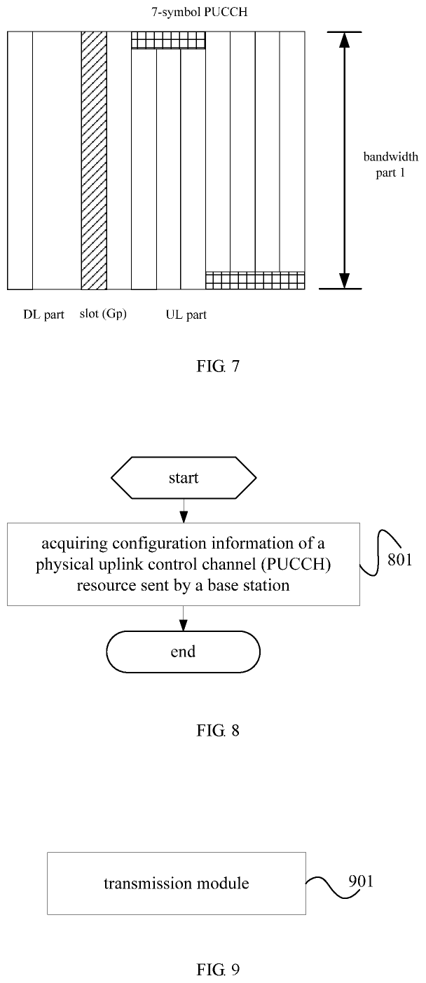

It should be noted that, in order to obtain the frequency diversity gain, the frequency hopping configuration may be activated for some PUCCH formats. Considering the gain and design complexity, the frequency hopping part may be divided into two parts, that is, PUCCH symbols may be divided into two parts, i.e., transmission in the bandwidth part (BP) or transmission outside the bandwidth part. For example, FIG. 4 shows frequency hopping of a 1-symbol PUCCH in CP-OFDM format. For a 2-symbol PUCCH and long-PUCCH, FIG. 5 shows frequency hopping of 2 symbols within the bandwidth part. FIG. 6 shows frequency hopping of 2 symbols between the bandwidth parts. For a PUCCH with a length of odd symbols, there may be two frequency hopping patterns. For example, for a 7-symbol PUCCH as shown in FIG. 7, when performing frequency hopped transmission, three or four symbols may be divided into a first part, as shown in FIG. 7. It should be noted that the frequency hopping identification information may be indicated by a high-level signaling or DCI signaling.

In the above figures, DL part represents a downlink part, UL part represents an uplink part, and GP represent a slot.

According to the solution of determining the PUCCH resource configuration in the embodiment of the present disclosure, when the base station sends the DCI of the downlink data to the terminal, the DCI carries the configuration information for indicating the PUCCH resource. This can flexibly allocate PUCCH formats and resources to the terminal according to the usage requirement, thereby effectively ensuring the reliability of 5G communication.

As shown in FIG. 8, one embodiment of the present disclosure provides a resource configuration method, which is applied to a terminal, including the following steps.

Step 801: acquiring configuration information of a physical uplink control channel (PUCCH) resource sent by a base station.

The configuration information includes at least one of a time interval from downlink data to feeding back PUCCH resource, waveform information employed for transmitting the PUCCH resource, acknowledgement/non-acknowledgement resource indication information, format information employed for feeding back the PUCCH resource, and frequency hopping identification information of the PUCCH resource.

Specifically, implementation of the step 801 includes:

receiving downlink control information (DCI) carrying the configuration information of the PUCCH resource;

acquiring the configuration information of the PUCCH resource in the DCI.

Specifically, when the configuration information includes the time interval from the downlink data to feeding back PUCCH resource, the time interval is one of a plurality of preset time intervals. The plurality of preset time intervals are set at equal intervals or unequal intervals.

Specifically, when the configuration information includes the acknowledgement/non-acknowledgement resource indication information, the acknowledgement/non-acknowledgement resource indication information includes: a resource set comprised of at least one resource; or, the acknowledgement/non-acknowledgement resource indication information includes: a resource and at least one offset.

Specifically, when the configuration information includes the format information employed for feeding back the PUCCH resource, if there are definite PUCCH formats and quantity in a slot, then the format information includes PUCCH identification information; if an uplink of a slot or an uplink slot includes dynamically variable PUCCH formats, then the format information includes a starting symbol position of the PUCCH and a length of the PUCCH.

Specifically, when a length of the transmission format of the PUCCH resource is smaller than or equal to a preset value, the format information is implicitly notified by the base station.

Specifically, when the configuration information includes the format information employed for feeding back the PUCCH resource, the format information is used to implicitly indicate uplink control information (UCI) sent by the terminal.

Specifically, when the configuration information includes the frequency hopping identification information of the PUCCH resource, the frequency hopping identification information includes: frequency hopping indication information and/or a long-PUCCH resource frequency hopping division indication.

The frequency hopping indication information includes: an intra-bandwidth part (BP) frequency hopping indication or an inter-BP frequency hopping indication.

It should be noted that all the descriptions on the terminal in the foregoing embodiments may be applied to the resource allocation method on the terminal, and the same technical effects can be achieved.

As shown in FIG. 9, one embodiment of the present disclosure provides a base station, including:

a transmission module 901 configured to transmit configuration information of a physical uplink control channel (PUCCH) resource to a terminal.

The configuration information includes at least one of a time interval from downlink data to feeding back PUCCH resource, waveform information employed for transmitting the PUCCH resource, acknowledgement/non-acknowledgement resource indication information, format information employed for feeding back the PUCCH resource, and frequency hopping identification information of the PUCCH resource.

Specifically, the transmission module 901 is configured to: transmit downlink control information (DCI) carrying the configuration information of the PUCCH resource to the terminal.

Specifically, when the configuration information includes the time interval from the downlink data to feeding back PUCCH resource, the time interval is one of a plurality of preset time intervals. The plurality of preset time intervals are set at equal intervals or unequal intervals.

Specifically, when the configuration information includes the acknowledgement/non-acknowledgement resource indication information, the acknowledgement/non-acknowledgement resource indication information includes: a resource set comprised of at least one resource; or, the acknowledgement/non-acknowledgement resource indication information includes: a resource and at least one offset.

Specifically, when the configuration information includes the format information employed for feeding back the PUCCH resource, if there are definite PUCCH formats and quantity in a slot, then the format information includes PUCCH identification information; if an uplink of a slot or an uplink slot includes dynamically variable PUCCH formats, then the format information includes a starting symbol position of the PUCCH and a length of the PUCCH.

Specifically, when a length of the transmission format of the PUCCH resource is smaller than or equal to a preset value, the format information is implicitly notified to the terminal.

Specifically, when the configuration information includes the format information employed for feeding back the PUCCH resource, the format information is used to implicitly indicate uplink control information (UCI) sent by the terminal.

Specifically, when the configuration information includes the frequency hopping identification information of the PUCCH resource, the frequency hopping identification information includes: frequency hopping indication information and/or a long-PUCCH resource frequency hopping division indication.

The frequency hopping indication information includes: an intra-bandwidth part (BP) frequency hopping indication or an inter-BP frequency hopping indication.

It should be noted that the base station embodiment is a base station corresponding to the resource configuration method applied to the base station, and all implementation manners of the foregoing embodiments are applicable to the base station embodiment, and the same technical effects can be achieved.

One embodiment of the present disclosure further provides a base station, including: a memory, a processor, and a computer program stored on the memory and executable on the processor. When the computer program is executed by the processor, each step of the resource configuration method applied to the base station in the above embodiment can be implemented, and the same technical effects can be achieved, which will not elaborated herein.

One embodiment of the present disclosure further provides a computer readable storage medium. The computer readable storage medium stores a computer program thereon. When the computer program is executed by the processor, each step of the resource configuration method applied to the base station in the above embodiment can be implemented, and the same technical effects can be achieved, which will not elaborated herein. The computer readable storage medium, for example, may be a read-only memory (ROM), a random access memory (RAM), a magnetic disk, and an optical disk.

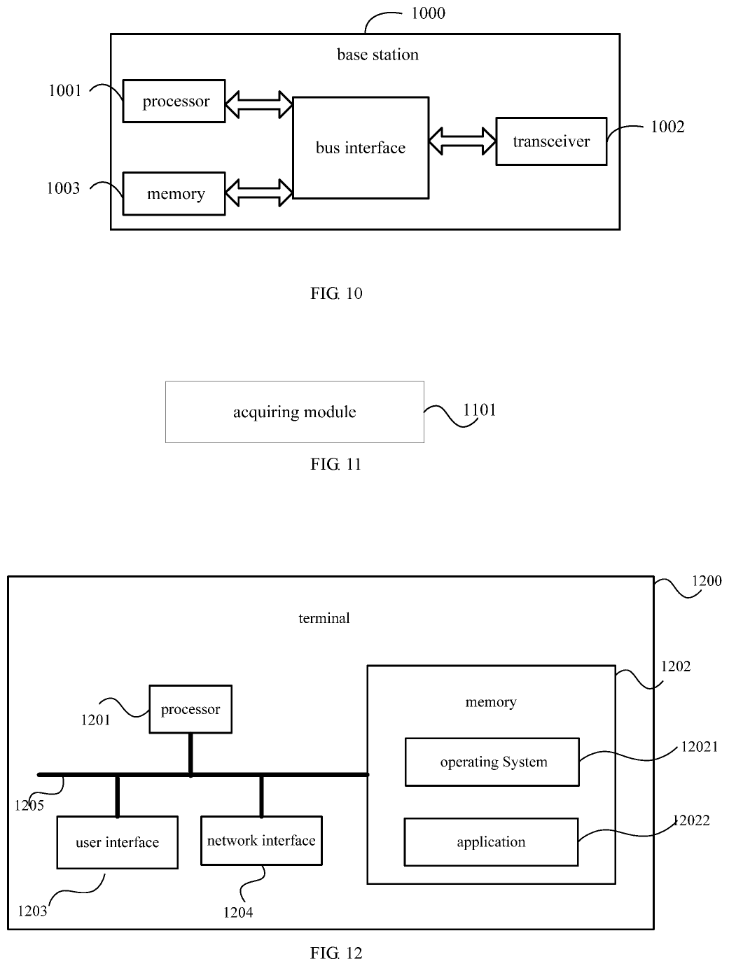

FIG. 10 is a block diagram of a base station according to an embodiment of the present disclosure. The base station can implement details of the resource configuration method applied to the base station in the above embodiment, and the same technical effects can be achieved. As shown in FIG. 10, the base station 1000 includes a processor 1001, a transceiver 1002, a memory 1003 and a bus interface.

The processor 1001 is configured to read a program in the memory 1003 and perform the following process:

transmitting configuration information of a physical uplink control channel (PUCCH) resource to a terminal through the transceiver 1002.

The configuration information includes at least one of a time interval from downlink data to feeding back PUCCH resource, waveform information employed for transmitting the PUCCH resource, acknowledgement/non-acknowledgement resource indication information, format information employed for feeding back the PUCCH resource, and frequency hopping identification information of the PUCCH resource.

In FIG. 10, the bus architecture may include any number of interconnected buses and bridges. Specifically, one or more processors represented by the processor 1001 and various circuits of memory represented by the memory 1003 are linked together. The bus architecture can also link various other circuits, such as peripherals, voltage regulators, and power management circuits, as is known in the art. Therefore, it will not be further described. The bus interface provides an interface. The transceiver 1002 may be multiple components, including a transmitter and a receiver, providing units for communicating with various other devices on a transmission medium.

The processor 1001 is in charge of managing bus architecture and general processing. The memory 1003 may store data used by the processor 1001 when performing operations.

Optionally, the processor 1001 is further configured to read the program in the memory 1003 and perform the following process:

transmitting downlink control information (DCI) carrying the configuration information of the PUCCH resource to the terminal through the transceiver 1002.

Specifically, when the configuration information includes the time interval from the downlink data to feeding back PUCCH resource, the time interval is one of a plurality of preset time intervals. The plurality of preset time intervals are set at equal intervals or unequal intervals.

Specifically, when the configuration information includes the acknowledgement/non-acknowledgement resource indication information, the acknowledgement/non-acknowledgement resource indication information includes: a resource set comprised of at least one resource; or, the acknowledgement/non-acknowledgement resource indication information includes: a resource and at least one offset.

Specifically, when the configuration information includes the format information employed for feeding back the PUCCH resource, if there are definite PUCCH formats and quantity in a slot, then the format information includes PUCCH identification information; if an uplink of a slot or an uplink slot includes dynamically variable PUCCH formats, then the format information includes a starting symbol position of the PUCCH and a length of the PUCCH.

Specifically, when a length of the transmission format of the PUCCH resource is smaller than or equal to a preset value, the format information is implicitly notified to the terminal.

Specifically, when the configuration information includes the format information employed for feeding back the PUCCH resource, the format information is used to implicitly indicate uplink control information (UCI) sent by the terminal.

Specifically, when the configuration information includes the frequency hopping identification information of the PUCCH resource, the frequency hopping identification information includes: frequency hopping indication information and/or a long-PUCCH resource frequency hopping division indication.

The frequency hopping indication information includes: an intra-bandwidth part (BP) frequency hopping indication or an inter-BP frequency hopping indication.

According to the base station in the embodiment of the present disclosure, the configuration information of the PUCCH resource is transmitted to the terminal, which can flexibly allocate PUCCH formats and resources to the terminal according to the usage requirement, thereby effectively ensuring the reliability of 5G communication.

As shown in FIG. 11, one embodiment of the present disclosure further provides a terminal, including:

an acquiring module 1101 is configured to acquire configuration information of a physical uplink control channel (PUCCH) resource sent by a base station.

The configuration information includes at least one of a time interval from downlink data to feeding back PUCCH resource, waveform information employed for transmitting the PUCCH resource, acknowledgement/non-acknowledgement resource indication information, format information employed for feeding back the PUCCH resource, and frequency hopping identification information of the PUCCH resource.

Specifically, the acquiring module 1101 includes:

a receiving unit configured to receive downlink control information (DCI) carrying the configuration information of the PUCCH resource; and

an acquiring unit configured to acquire the configuration information of the PUCCH resource in the DCI.

Specifically, when the configuration information includes the time interval from the downlink data to feeding back PUCCH resource, the time interval is one of a plurality of preset time intervals. The plurality of preset time intervals are set at equal intervals or unequal intervals.

Specifically, when the configuration information includes the acknowledgement/non-acknowledgement resource indication information, the acknowledgement/non-acknowledgement resource indication information includes: a resource set comprised of at least one resource; or, the acknowledgement/non-acknowledgement resource indication information includes: a resource and at least one offset.

Specifically, when the configuration information includes the format information employed for feeding back the PUCCH resource, if there are definite PUCCH formats and quantity in a slot, then the format information includes PUCCH identification information; if an uplink of a slot or an uplink slot includes dynamically variable PUCCH formats, then the format information includes a starting symbol position of the PUCCH and a length of the PUCCH.

Specifically, when a length of the transmission format of the PUCCH resource is smaller than or equal to a preset value, the format information is implicitly notified by the base station.

Specifically, when the configuration information includes the format information employed for feeding back the PUCCH resource, the format information is used to implicitly indicate uplink control information (UCI) sent by the terminal.

Specifically, when the configuration information includes the frequency hopping identification information of the PUCCH resource, the frequency hopping identification information includes: frequency hopping indication information and/or a long-PUCCH resource frequency hopping division indication.

The frequency hopping indication information includes: an intra-bandwidth part (BP) frequency hopping indication or an inter-BP frequency hopping indication.

It should be noted that the terminal embodiment is a terminal corresponding to the resource configuration method applied to the terminal, and all implementation manners of the foregoing embodiments are applicable to the terminal embodiment, and the same technical effects can be achieved.

One embodiment of the present disclosure further provides a terminal, including: a memory, a processor, and a computer program stored on the memory and executable on the processor. When the computer program is executed by the processor, each steps of the resource configuration method applied to the terminal in the above embodiment can be implemented, and the same technical effects can be achieved, which will not elaborated herein.

One embodiment of the present disclosure further provides a computer readable storage medium. The computer readable storage medium stores a computer program thereon. When the computer program is executed by the processor, each step of the resource configuration method applied to the terminal in the above embodiment can be implemented, and the same technical effects can be achieved, which will not elaborated herein. The computer readable storage medium, for example, may be a read-only memory (ROM), a random access memory (RAM), a magnetic disk, and an optical disk.

FIG. 12 is a block diagram of a terminal according to an embodiment of the present disclosure. The application entity of the resource configuration method applied to the terminal of the present disclosure will be described hereinafter in conjunction with the figure.

The terminal 1200 shown in FIG. 12 includes at least one processor 1201, a memory 1202, at least one network interface 1204 and a user interface 1203. Various components in the terminal 1200 are coupled together by a bus system 1205. It should be understood that, the bus system 1205 is configured to implement connection communication among these components. In addition to data bus, the bus system 1205 further includes power bus, control bus and status signal bus. However, for clarity of description, various buses are labeled as the bus system 1205 in FIG. 12.

The user interface 1203 may include a display device, a keyboard, or a clicking device (e.g., a mouse, a trackball, a touchpad, or a touch screen, etc.).

It should be understood that, in the embodiment of the present disclosure, the memory 1202 may be a transitory memory, or a non-transitory memory, or may include both of the transitory memory and the non-transitory memory. The non-transitory memory may be a Read-Only Memory (ROM), a Programmable ROM (PROM), an Erasable PROM (EPROM), an Electrically EPROM (EEPROM), or a flash memory. The transitory memory may be a Random Access Memory (RAM), which is used as an external cache. Many forms of RAM are available by way of illustration and not limitation, e.g., a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM) and a Direct Rambus RAM (DRRAM). The memory 1202 of the systems and methods described in the application is intended to include, without being limited to, these and any other suitable types of memory.

In some implementations, the memory 1202 stores the following elements, executable modules, or data structures, or a subset thereof, or an extended set thereof: an Operating System (OS) 12021 and an application 12022.

The OS 12021 includes various system programs, e.g., a frame layer, a core library layer, a driver layer, etc., are used to implement various basic services and to handle hardware-based tasks. The application 12022 includes various applications, such as a media player (Media Player), a browser, and so on, for implementing various application services. A program implementing the method of the embodiments in the present disclosure may be included in the application 12022.

In one embodiment of the present disclosure, the mobile terminal 1200 further includes: a computer program stored on the memory 1202 and executable on the processor 1201. Specifically, the computer program may be a computer control program in the application 12022. The computer program is executed by the processor 1201 to implement the following step of acquiring configuration information of a physical uplink control channel (PUCCH) resource sent by the base station.

The configuration information includes at least one of a time interval from downlink data to feeding back PUCCH resource, waveform information employed for transmitting the PUCCH resource, acknowledgement/non-acknowledgement resource indication information, format information employed for feeding back the PUCCH resource, and frequency hopping identification information of the PUCCH resource.

The method provided by foregoing embodiments of the present disclosure may be applied to the processor 1201, or may be implemented by the processor 1201. The processor 1201 may be an integrated circuit chip with signal processing capability. During the implementation process, each step of the foregoing method may be completed by an integrated logic circuit of hardware in the processor 1201, or by an instruction in a form of software. The foregoing processor 1201 may be a general processor, a Digital Signal Processor (DSP), an Application Specific Integrated Circuit (ASIC), a Field Programmable Gate Array (FPGA), or other programmable logic devices, discrete gate or transistor logic device, discrete hardware components. Each method, step, and logic diagram provided by the embodiment of the present disclosure may be implemented, or executed. The general processor may be a microprocessor, or any conventional processor, and so on. The steps of the method provided by the embodiments of the present disclosure may be directly completed by the hardware decoding processor, or may be completed by a combination of hardware and software modules in the decoding processor. The software modules may be located in mature storage medium in the field, such as, the RAM, the flash memory, the ROM, the PROM, Electrically erasable programmable memory, and a register. The storage medium is located in the memory 1202. The processor 1201 reads information from the memory 1202, and completes steps of foregoing method in combination with the hardware.

It should be understood that, these embodiments described in the application may be implemented by hardware, software, firmware, middleware, microcode, or a combination thereof. For hardware implementation, in the one or more ASICs, DSPs, DSP Device (DSPDs), Programmable Logic Devices (PLDs), FPGAs, general processors, controllers, microcontrollers, microprocessors, a processing unit may be implemented in another electronic unit or a combination thereof, which is configured to implement the functions of the application.

For software implementation, techniques described in the application may be implemented, by executing modules (e.g., process, function, etc.) with corresponding functions in the application. Software codes may be stored in the memory, and executed by the processor. The memory may be implemented in the processor, or external to the processor.

Optionally, the computer program is executed by the processor 1201 to implement: receiving downlink control information (DCI) carrying the configuration information of the PUCCH resource, and acquiring the configuration information of the PUCCH resource in the DCI.

Specifically, when the configuration information includes the time interval from the downlink data to feeding back PUCCH resource, the time interval is one of a plurality of preset time intervals. The plurality of preset time intervals are set at equal intervals or unequal intervals.

Specifically, when the configuration information includes the acknowledgement/non-acknowledgement resource indication information, the acknowledgement/non-acknowledgement resource indication information includes: a resource set comprised of at least one resource; or, the acknowledgement/non-acknowledgement resource indication information includes: a resource and at least one offset.

Specifically, when the configuration information includes the format information employed for feeding back the PUCCH resource, if there are definite PUCCH formats and quantity in a slot, then the format information includes PUCCH identification information; if an uplink of a slot or an uplink slot includes dynamically variable PUCCH formats, then the format information includes a starting symbol position of the PUCCH and a length of the PUCCH.

Specifically, when a length of the transmission format of the PUCCH resource is smaller than or equal to a preset value, the format information is implicitly notified by the base station.

Specifically, when the configuration information includes the format information employed for feeding back the PUCCH resource, the format information is used to implicitly indicate uplink control information (UCI) sent by the terminal.

Specifically, when the configuration information includes the frequency hopping identification information of the PUCCH resource, the frequency hopping identification information includes: frequency hopping indication information and/or a long-PUCCH resource frequency hopping division indication.

The frequency hopping indication information includes: an intra-bandwidth part (BP) frequency hopping indication or an inter-BP frequency hopping indication.

The terminal 1200 can implement various processes implemented by the terminal in the foregoing embodiment. To avoid repetition, details are not described herein again.

The terminal of the embodiment of the present disclosure can flexibly use the PUCCH formats and resources according to usage requirements, thereby improving communication efficiency and ensuring reliability of 5G communication.

The various embodiments in the present specification are described in a progressive manner, and each embodiment focuses on differences from other embodiments, and the same similar parts between the various embodiments can be referred to each other.

Those skilled in the art will appreciate that embodiments of the present disclosure can be provided as a method, an apparatus, or a computer program product. Thus, embodiments of the present disclosure may take the form of an entire hardware embodiment, an entire software embodiment, or a combination of software and hardware. Moreover, the embodiments of the present disclosure may take the form of a computer program product embodied on one or more computer-usable storage media (including but not limited to a disk storage, CD-ROM, an optical storage, etc.) including computer usable program code.

The present disclosure has been described with reference to the flow charts and/or block diagrams of the method, device (system) and computer program product according to the embodiments of the present disclosure. It should be understood that computer program instructions may be used to implement each of the work flows and/or blocks in the flow charts and/or the block diagrams, and the combination of the work flows and/or blocks in the flow charts and/or the block diagrams. These computer program instructions may be provided to a processor of a common computer, a dedicate computer, an embedded processor or any other programmable data processing devices to create a machine, so that instructions executable by the processor of the computer or the other programmable data processing devices may create a device to achieve the functions assigned in one or more work flows in the flow chart and/or one or more blocks in the block diagram.

These computer program instructions may also be stored in a computer readable storage that may guide the computer or the other programmable data process devices to function in a certain way, so that the instructions stored in the computer readable storage may create a product including an instruction unit which achieves the functions assigned in one or more flows in the flow chart and/or one or more blocks in the block diagram.

These computer program instructions may also be loaded in the computer or the other programmable data process devices, so that a series of operation steps are executed on the computer or the other programmable devices to create processes achieved by the computer. Therefore, the instructions executed in the computer or the other programmable devices provide the steps for achieving the function assigned in one or more flows in the flow chart and/or one or more blocks in the block diagram.

The above are merely the preferred embodiments of the present disclosure and shall not be used to limit the scope of the present disclosure. It should be noted that, a person skilled in the art may make improvements and modifications without departing from the principle of the present disclosure, and these improvements and modifications shall also fall within the scope of the present disclosure.

It should also be noted that in this application, relational terms such as first and second are merely used to differentiate different components rather than to represent any order, number or importance. Further, the term “including”, “include” or any variants thereof is intended to cover a non-exclusive contain, so that a process, a method, an article or a terminal device, which includes a series of elements, includes not only those elements, but also includes other elements which are not explicitly listed, or elements inherent in such a process, method, article or terminal device. In absence of any further restrictions, an element defined by the phrase “including one . . . ” does not exclude the existence of additional identical elements in a process, method, article, or terminal device that includes the element.

The above are merely the preferred embodiments of the present disclosure. It should be noted that, a person skilled in the art may make improvements and modifications without departing from the principle of the present disclosure, and these improvements and modifications shall also fall within the scope of the present disclosure.

What is claimed is:

1. A resource configuration method, comprising:
transmitting configuration information of a physical uplink control channel (PUCCH) resource to a terminal;
wherein the configuration information comprises at least one of a time interval from downlink data to feeding back PUCCH resource, waveform information employed for transmitting the PUCCH resource, acknowledgement/non-acknowledgement resource indication information, format information employed for feeding back the PUCCH resource, and frequency hopping identification information of the PUCCH resource.

2. The resource configuration method according to claim 1, wherein the step of transmitting the configuration information of the PUCCH resource to the terminal, comprises:
transmitting downlink control information (DCI) carrying the configuration information of the PUCCH resource to the terminal.

3. The resource configuration method according to claim 1, wherein when the configuration information comprises the time interval from the downlink data to feeding back PUCCH resource, the time interval is one of a plurality of preset time intervals; and the plurality of preset time intervals are set at equal intervals or unequal intervals.

4. The resource configuration method according to claim 1, wherein when the configuration information comprises the acknowledgement/non-acknowledgement resource indication information, the acknowledgement/non-acknowledgement resource indication information comprises a resource set comprising comprised of at least one resource; or, the acknowledgement/non-acknowledgement resource indication information comprises a resource and at least one offset.

5. The resource configuration method according to claim 1, wherein when the configuration information comprises the format information employed for feeding back the PUCCH resource, if there are definite PUCCH formats and quantity in a slot, then the format information comprises PUCCH identification information; if an uplink of a slot or an uplink slot comprises dynamically variable PUCCH formats, then the format information comprises a starting symbol position of the PUCCH and a length of the PUCCH.

6. The resource configuration method according to claim 5, wherein when a length of a transmission format of the PUCCH resource is smaller than or equal to a preset value, the format information is implicitly notified to the terminal.

7. The resource configuration method according to claim 1, wherein when the configuration information comprises the format information employed for feeding back the PUCCH resource, the format information is used to implicitly indicate uplink control information (UCI) sent by the terminal.

8. The resource configuration method according to claim 1, wherein when the configuration information comprises the frequency hopping identification information of the PUCCH resource, the frequency hopping identification information comprises: frequency hopping indication information and/or a long-PUCCH resource frequency hopping division indication;
wherein the frequency hopping indication information comprises an intra-bandwidth part (BP) frequency hopping indication or an inter-BP frequency hopping indication.

9. A resource configuration method, comprising:
acquiring configuration information of a physical uplink control channel (PUCCH) resource sent by a base station;
wherein the configuration information comprises at least one of a time interval from downlink data to feeding back PUCCH resource, waveform information employed for transmitting the PUCCH resource, acknowledgement/non-acknowledgement resource indication information, format information employed for feeding back the PUCCH resource, and frequency hopping identification information of the PUCCH resource.

10. The resource configuration method according to claim 9, wherein the step of acquiring the configuration information of the PUCCH resource sent by the base station, comprises:
receiving downlink control information (DCI) carrying the configuration information of the PUCCH resource; and
acquiring the configuration information of the PUCCH resource in the DCI.

11. The resource configuration method according to claim 9, wherein when the configuration information comprises the time interval from the downlink data to feeding back PUCCH resource, the time interval is one of a plurality of preset time intervals; and the plurality of preset time intervals are set at equal intervals or unequal intervals.

12. The resource configuration method according to claim 9, wherein when the configuration information comprises the acknowledgement/non-acknowledgement resource indication information, the acknowledgement/non-acknowledgement resource indication information comprises a resource set comprised of at least one resource; or, the acknowledgement/non-acknowledgement resource indication information comprises a resource and at least one offset.

13. The resource configuration method according to claim 9, wherein when the configuration information comprises the format information employed for feeding back the PUCCH resource, if there are definite PUCCH formats and quantity in a slot, then the format information comprises PUCCH identification information; if an uplink of a slot or an uplink slot comprises dynamically variable PUCCH formats, then the format information comprises a starting symbol position of the PUCCH and a length of the PUCCH.

14. The resource configuration method according to claim 13, wherein when a length of a transmission format of the PUCCH resource is smaller than or equal to a preset value, the format information is implicitly notified by the base station.

15. The resource configuration method according to claim 9, wherein when the configuration information comprises the format information employed for feeding back the PUCCH resource, the format information is used to implicitly indicate uplink control information (UCI) sent by the terminal.

16. The resource configuration method according to claim 9, wherein when the configuration information comprises the frequency hopping identification information of the PUCCH resource, the frequency hopping identification information comprises: frequency hopping indication information and/or a long-PUCCH resource frequency hopping division indication;
wherein the frequency hopping indication information comprises an intra-bandwidth part (BP) frequency hopping indication or an inter-BP frequency hopping indication.

17-24. (canceled)

25. A base station, comprising: a memory, a processor, and a computer program stored on the memory and executable on the processor; wherein the computer program is executed by the processor to implement steps of the resource configuration method according to claim 1.

26. A computer readable storage medium, comprising a computer program stored thereon; wherein the computer program is executed by a processor to implement steps of the resource configuration method according to claim 1.

27-34. (canceled)

35. A terminal, comprising: a memory, a processor, and a computer program stored on the memory and executable on the processor; wherein the computer program is executed by the processor to implement steps of the resource configuration method according to claim 9.

36. A computer readable storage medium, comprising a computer program stored thereon; wherein the computer program is executed by a processor to implement steps of the resource configuration method according to claim 9.
